(19) United States
(12) Patent Application Publication
(10) Pub. No.: US 2015/0048209 A1
(43) Pub. Date: Feb. 19, 2015

(54) Structures with Internal Microstructures to Provide Multifunctional Capabilities

(71) Applicants: Robert Hoyt, Bothell, WA (US); Jonathan Wrobel, Bothell, WA (US); Jesse Cushing, Bothell, WA (US); Mark Jaster, Bothell, WA (US); Nestor Voronka, Bothell, WA (US); Scott Frank, Bothell, WA (US); Jeffrey Slostad, Bothell, WA (US); Leonid Paritsky, Bothell, WA (US)

(72) Inventors: Robert Hoyt, Bothell, WA (US); Jonathan Wrobel, Bothell, WA (US); Jesse Cushing, Bothell, WA (US); Mark Jaster, Bothell, WA (US); Nestor Voronka, Bothell, WA (US); Scott Frank, Bothell, WA (US); Jeffrey Slostad, Bothell, WA (US); Leonid Paritsky, Bothell, WA (US)

(21) Appl. No.: 14/462,541

(22) Filed: Aug. 18, 2014

Related U.S. Application Data
(60) Provisional application No. 61/866,539, filed on Aug. 16, 2013.

(51) Int. Cl. B64G 1/54; B22F 7/02; B22F 3/105; B64G 1/22; B29C 67/00

(52) U.S. Cl. CPC B64G 1/54; B64G 1/22; B29C 67/0077; B29C 67/0059; B22F 3/1055; B22F 7/02; B29K 2101/12
USPC 244/131; 264/497; 264/308; 419/53; 419/66

(57) ABSTRACT

A structural spacecraft component comprising internal microstructure; wherein said microstructure comprises a plurality of parallel layers and a plurality of spacers that connect adjacent parallel layers; wherein said structural spacecraft component is a product of an additive manufacturing process.

### CROSS REFERENCE TO RELATED APPLICATIONS

This application claims the benefit of U.S. provisional patent application No. 61/866,539.

### STATEMENTS RELATED TO FEDERALLY SPONSORED RESEARCH AND DEVELOPMENT

This invention was made with Government support under FA9453-12-M-0336 awarded by the United States Air Force. The Government has certain rights in the invention.

This invention was made with Government support under W31P4Q09C0147 awarded by DARPA. The Government has certain rights in the invention.

### SUMMARY

A structural spacecraft component comprising internal microstructure; wherein said microstructure's shape comprises a plurality of parallel layers and a plurality of spacers that connect adjacent parallel layers; wherein said structural spacecraft component is a product of an additive manufacturing process.

### BACKGROUND

For thermal isolation, current satellite systems use Multi-Layer Insulation (MLI) blankets, made of multiple layers of thin metalized membranes, applied to the exterior of the satellite. These blankets are expensive to fabricate, typically must be customized for each application, and are delicate, often damaged during spacecraft integration. Additionally, Multi-Layer Insulation's thermal insulation performance is highly dependent upon how it is installed, as overlaps, gaps, and other factors can dramatically affect its effective emissivity. This makes it difficult to predict Multi-Layer Insulation's as-installed performance.

The radiation environment in Earth orbit, and of specific interest Geo-stationary Earth Orbit (GEO), consists of electron, proton, photon, and neutron components. This environment is dynamic, and is affected by the interplay between the solar wind and Earth's magnetosphere. Specific radiation dosing and incident particle energies are highly dependent on the satellite's position in orbit as well as solar activity.

Radiation adversely affects electronics via a number of mechanisms, including reduced stability and decreased reliability in the short term and shortened lifespan and increased power consumption in the long-term:
Single event effects (SEE), where internal ionization from a proton or electron transiting an electronic device can cause temporary or permanent effects.
Transient dose effects, where periods of high radiation flux causing photo currents in semiconductors and random switching of transistors result in changed memory states, permanent damage from sustained fluxes, or latch up.
Total ionizing dose (TID), where accumulated deep dielectric charging results in slow degradation of solid-state components until persistent gate biasing renders the device unusable.

To guard against these effects mission designers will radiation harden their electronics through a number of approaches. Typically, radiation hardening is achieved by a combination of: 1) modifying the electronics by changing the scale of the etching or the materials used, 2) increasing fault tolerance by using redundancy and voting schemes, or 3) by shielding the electronics to reduce the radiation environment near the electronics and achieve fault avoidance.

For radiation shielding, spacecraft systems typically use aluminum enclosures with spot shielding by manually applying thin tantalum plates near sensitive components. Spot shielding in this manner can incur significant labor costs.

### BRIEF DESCRIPTION OF DRAWINGS

FIG. 1 shows an example of Structural Multi-Layer Insulation 100 according to an embodiment comprising a 3D-printed structural element incorporating a multi-layer thermal/radiation barrier.

FIG. 2 shows graded-Z Versatile Structural Radiation Shielding made by additive manufacturing in accordance with an embodiment.

FIG. 3 shows conformal graded-Z Versatile Structural Radiation Shielding made by additive manufacturing in accordance with an embodiment.

FIG. 4 shows Versatile Structural Radiation Shielding made by additive manufacturing in accordance with an embodiment.

FIG. 5 shows Versatile Structural Radiation Shielding incorporating EMI shielding, radiation shielding, and a thermal shunt made by additive manufacturing in accordance with an embodiment.

FIG. 6 shows Versatile Structural Radiation Shielding multifunctional isogrid paneling in accordance with an embodiment.

FIG. 7 shows a satellite design and assembly process using S-MLI exoskeleton in accordance with an embodiment.

The scope of the invention is only limited by the claims, and not by examples of embodiments shown in the drawings.

### DETAILED DESCRIPTION

An example method could comprise printing Versatile Structural Radiation Shielding by additive manufacture and applying a thin metal exoskeleton to the shielding's surfaces.

An example method can enable rapid implementation of customized and optimized spacecraft with thermal and radiation shielding. Steps could comprise:
design in CAD;
validate structural/thermal/radiation in simulation;
fabricate using 3D printing; and
integrate & validate fabricated components.

Additive manufacturing enables creation of spacecraft structures having complex internal microstructures not seen in traditionally fabricated components to provide multifunctional capabilities. An embodiment comprising Versatile Structural Radiation Shielding enables 3D printed covers and enclosures that reduce the mass required for shielding avionics. An embodiment comprising Versatile Structural Radiation Shielding has predictable thermal and shielding performance, thereby reducing the risk for responsive development cycles

An example embodiment comprising Versatile Structural Radiation Shielding enables approximately 50% mass reduction compared to traditional structures.

An example embodiment comprises a flat-panel structural element incorporating an integrated multi-layer thermal barrier. Example methods comprise 3D printing and electroless plating steps to fabricate a structure and coat the structure with metallic surfaces to improve its radiative characteristics and significantly enhance its strength. An example embodiment comprising Structural Multilayer Insulation can have an effective emissivity of 0.06±0.01, a value that is comparable to the effective emissivity of conventional multilayer insulation that is installed on a spacecraft. Example Structural Multilayer Insulation panels according to an embodiment have strength and stiffness comparable to and exceeding that of conventional honeycomb, albeit at a higher areal density. An embodiment comprising Structural Multilayer Insulation has strong potential for creating spacecraft structures that provide thermal and strength performance comparable to the conventional approach of aluminum structure covered by a

Multilayer Insulation blanket. Structural Multilayer Insulation components according to an embodiment can be manufactured using rapid prototyping techniques such as 3D printing, however, and can serve as a key component of a “Printable Satellite” technology that would enable spacecraft to be designed, analyzed, fabricated, and integrated in a dramatically more rapid and responsive manner.

An example method according to an embodiment comprises a step of utilizing 3D printing technologies to fabricate spacecraft structural elements that incorporate integral multi-layer thermal barriers. An example Structural Multi Layer Insulation 100 element according to an embodiment comprises a plurality of thin layers that are mechanically connected by a sparse pattern of stand-off spacers. An example method of manufacturing Structural Multilayer Insulation in accordance with an embodiment comprises a step of Selective Laser Sintering working material, such as glass-filled nylon, to form a plurality of thin layers that are mechanically connected by a sparse pattern of stand-off spacers. Selective Laser Sintering provides a good combination of features for space structures, including shape flexibility, high-strength, and low outgassing material options. An example method comprises a step of plating of all interior and exterior surfaces of the working material with metal, such as Electroless Nickel. This should preferably be done without deformation of the structure, and the thin metallic plating also significantly increases the stiffness and strength of the Structural Multilayer Insulation. An example embodiment comprising Structural Multilayer Insulation components can provide structural strength and a good radiative barrier. Furthermore, the flexibility and speed of the rapid prototyping technologies used to fabricate Structural Multi Layer Insulation 100 technology can enable a dramatic change in the way satellites are designed and built. Instead of designing a satellite's layout and structural elements based upon shapes that can be readily machined from flat plates of aluminum, blocks of metal, and flat sheets of honeycomb panel, satellite designers can chose optimal payload and component layouts and use an example method of manufacturing Structural Multi Layer Insulation 100 comprising a step of using automated CAD processes to create a computer readable file that represents the shape of conformal Structural Multi Layer Insulation that is ‘wrapped’ around these components. The conformal Structural Multi Layer Insulation 100 is shaped to protect the optimally configured components and payload. Structural Multi Layer Insulation 100 can be quickly printed and assembled in accordance with an example method, enabling responsive design, construction, and deployment of spacecraft optimized for each emerging situation.

Multi-Layer Insulation (MLI)

Insulating spacecraft components against the extreme temperatures that a spacecraft experiences in space is critical to ensuring reliable long-duration operation of the spacecraft. Because the temperature of the exterior of a spacecraft can vary several hundred degrees centigrade as it goes in and out of eclipse, it is usually necessary to thermally isolate the interior of the spacecraft from its exterior as well as possible in order to minimize the thermal cycling of the spacecraft's components. Multi-layer insulation (MLI) is the standard means of providing such a thermal barrier. MLI consists of multiple layers of metalized Mylar or Kapton film, with a thin netting of an insulating polymer material such as Nomex placed in between each layer of film to ensure that the film layers do not directly make contact. MLI works by minimizing the cross-section for conductive heat transfer between layers and using the multiple layers of film as radiation barriers to minimize the emissivity of the satellite.

Challenges with Conventional MLI

The performance of MLI is strongly dependent upon the manner in which it is attached to the spacecraft. Areas where sections of MLI overlap and any areas that are left uncovered can dramatically reduce its insulative performance. As a result, MLI blankets must be designed and sewn together in a custom manner for each spacecraft so that they fit together perfectly. This process is time-consuming and expensive. Because its performance is so dependent upon how well the individual blanket panels fit together, and how they make contact with the structure below, its performance is difficult to predict or model with a high level of accuracy. Additionally, because MLI is constructed of thin films to minimize weight, it is difficult to handle without damaging and is therefore susceptible to puncture and tearing during spacecraft assembly and integration. As a result, it must be integrated in a painstakingly slow and careful manner. While this slow process is fine for many spacecraft systems, it poses a challenge for development and deployment of low-cost and responsive satellite systems.

STRUCTURAL MULTI-LAYER INSULATION (S-MLI)

An example method comprises using 3D printing technologies to fabricate structures for satellites that incorporate integral and conformal multi-layer radiative barriers. An example of a ‘Structural MLI’ (S-MLI) can be fabricated using 3D printing techniques. Structural MLI can comprise an inner structural layer and layers that are “pre-bowed” to accommodate thermal expansion.

An example Structural Multi-Layer Insulation 100 according to an embodiment comprises a 3D-printable structural element incorporating a multi-layer radiative thermal barrier. The Structural Multi-Layer Insulation 100 comprises an inner structural layer that supports the physical loads experienced by a satellite, and comprises an outer ‘shell’ layer 10, that provides a durable outer surface that is resistant to damage and may, if necessary, have sufficient strength to support patch antennas, solar cells, and other such surface-mounted components. Between the outer shell 10 and the inner support structure the example Structural Multi-Layer Insulation 100 comprises multiple thin layers separated by thin support ribs. An example embodiment can comprise support ribs attached to the inner surface 50, wherein the support ribs' density is tuned to balance the need to minimize the area over which thermal conduction can occur while achieving the structural strength necessary to support expected loads.

During an example 3D printing process, structure is built up by laying down a solid material, such as a polymer or resin, in thin layers. If additional strength beyond that offered by the printable materials is required, an example method can comprise a step of adding layers of high-strength, temperature-tolerant composites such as carbon fiber, to the Structural Multi-Layer Insulation's inner surface 50 and outer surface 10.

An example Structural Multi-Layer Insulation 100 component can have a simple flat planar shape, but it should be appreciated that more complex geometries are possible. In cases where more complex shapes are needed, an example method comprises steps where a 3D printing process produces a satellite structure comprising a group of shell segments that conformally encase a satellite's components. Using an example automated process, which could be implemented as a custom ‘action’ command within a design tool such as SolidWorks, conformal shell segments can be designed on a sub-millimeter scale to incorporate multi-layer insulation. An example method comprises creating a file on a computer readable medium wherein the file describes the shape of a Structural Multi-Layer Insulation component that comprises a plurality of parallel planes and spacers that connect adjacent planes; and wherein software running on a computer can use said file to instruct a 3d printer to print a Structural Multi-Layer Insulation component having said shape. An example method comprises steps wherein a plurality of shell segments are fabricated using the 3D printing, the shell segments are coated, and the shell segments are assembled and integrated.

An embodiment can comprise a satellite construction method comprising a step of using segments of conformal Structural Multi-Layer Insulation 100. An embodiment can comprise an EO sensor, fuel tank, and avionics box integrated together with a box-shaped avionics box and held together with Structural Multi-Layer Insulation 100.

An example flat panel Structural Multi-Layer Insulation 100 component could serve as a replacement for an aluminum honeycomb panel with conventional MLI. Because Structural Multi-Layer Insulation 100 provides structural support of the outer layer, it could enable sensors and other components to be mounted on the outer surface of the spacecraft while still providing good thermal insulation. An example structure, could comprise an entire spacecraft structure with integral thermal barriers constructed using 3D printing.

A number of different rapid prototyping processes and materials could be used to fabricate Structural Multi-Layer Insulation 100 panels. Selective Laser Sintering (SLS) has flexibility in achieving small feature sizes and complex shapes, and works with high-strength and low-outgassing materials, and is low cost. Other rapid prototyping processes include Electron Beam Melting (EBM) and Three Dimensional Printing (3DPTM), which all have good material strength-per-weight.

An example method using rapid prototyping techniques to fabricate Structural-MLI could enable current frame and panel satellite construction techniques to be mostly or completely replaced by integral, conformal Structural-MLI, potentially resulting in dramatic improvements in the way satellites are configured, designed, and assembled.

An example Structural-MLI can comprise a flat, multilayered structure, separated by small, rectangular spacers in accordance with an embodiment. The spacers can be oriented in a ‘tread plate’ pattern so that they are staggered in position from one layer to the next to reduce the straight-line thermal conduction path from top surface to bottom surface. This design affords good compression strength and flexural rigidity, while minimizing thermal conduction pathways. Additionally, the open cell structure allows for evacuation of air and gases without risking catastrophic failure due to decompression.

An example process can comprise Selective Laser Sintering coupled with a customized metal plating process for plating of rapid prototyped parts. This process yields a very lightweight, high strength composite structure ideal for Structural Multi-Layer Insulation 100. Additionally, the full skin metallization of the polymer parts ensures they are completely sealed, and may prevent out-gassing regardless of the polymer material substrate used.

An embodiment can comprise Structural Multi-Layer Insulation 100 that has been plated in accordance with an embodiment. Examples of plating methods can include Room Temperature Electroless Nickel (RTEN)/electrolytic Copper/High Temperature Electroless Nickel (HTEN); RTEN only; vapor deposited stainless steel; and vapor deposited aluminum.

An embodiment can comprise unplated Structural Multi-Layer Insulation 100 in accordance with an embodiment. Structural Multi-Layer Insulation 100 panels can comprise through-holes for panel fasteners or feed-throughs, a finger-joint arrangement of panel layers to create joints that minimize radiative heat leakage through seams between panels, and tread-plate pattern spacers.

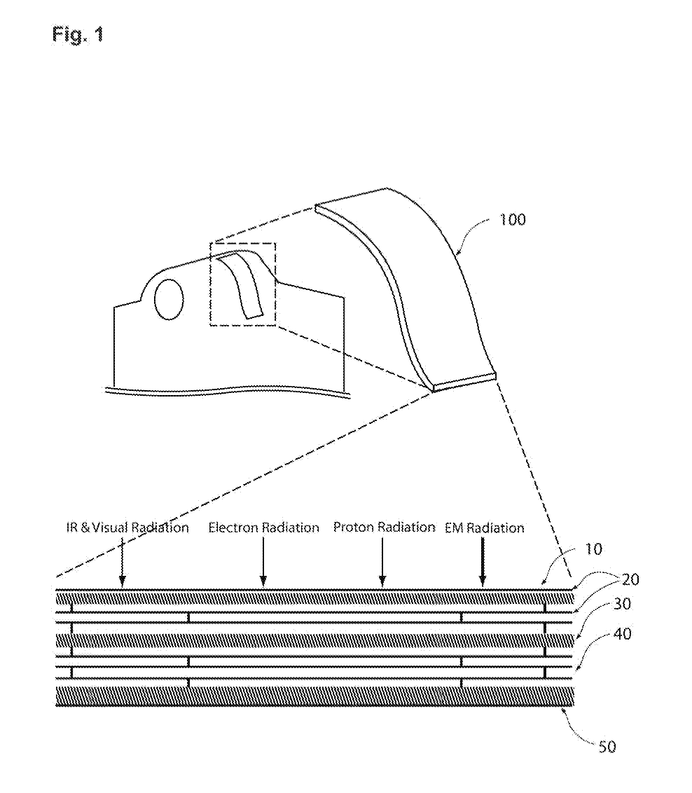

FIG. 1 shows an example of Structural Multi-Layer Insulation 100 according to an embodiment comprising a 3D-printed structural element incorporating a multi-layer thermal/radiation barrier. It comprises a low-Z outer shell layer 10 connected by spacers 40 to a first set of electroplated low emissivity inner layers 20. The first set of electroplated low emissivity inner layers 20 are connected to one another by spacers 40. The first set of electroplated low emissivity inner layers 20 are connected by spacers 40 a high-Z layer 30. The high-Z layer 30 is connected by spacers 40 to a second set of electroplated low emissivity layers 20. The second set of electroplated low emissivity layers 20 are connected to one another by spacers 40. The second set of electroplated low emissivity layers 20 is connected by spacers 40 to an inner structural low-Z layer.

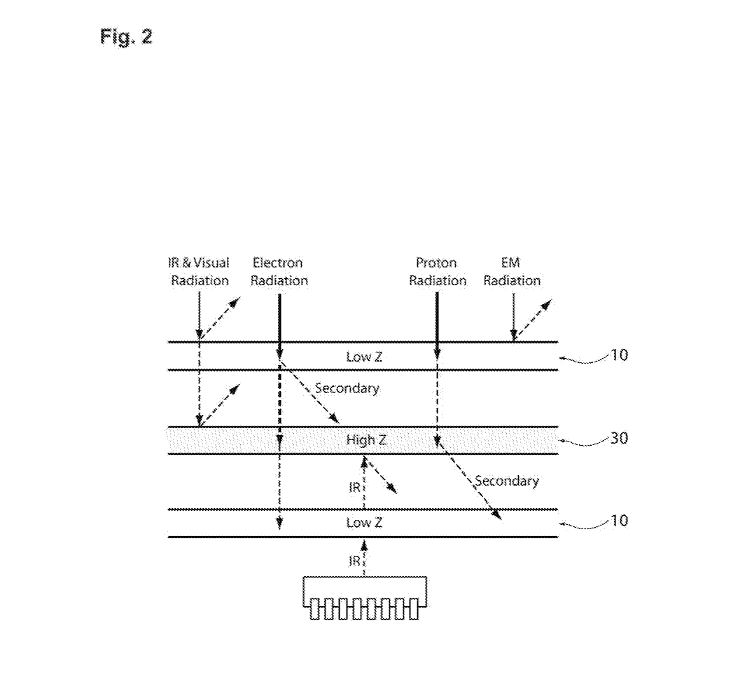

FIG. 2 shows graded-Z Versatile Structural Radiation Shielding 100 made by additive manufacturing in accordance with an embodiment. It comprises a high-Z layer 30 positioned between low-Z layers 10.

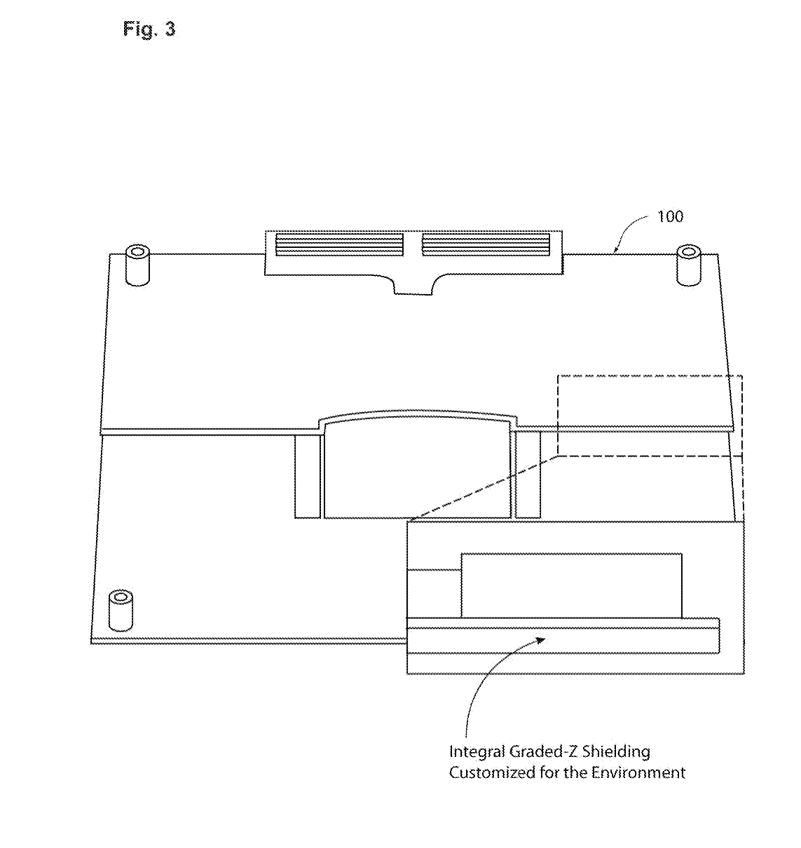

FIG. 3 shows conformal graded-Z Versatile Structural Radiation Shielding 100 made by additive manufacturing in accordance with an embodiment. It comprises a high-Z layer 30 comprising tungsten that is positioned between low-Z layers 10. It can be 3D printed and provides graded-Z shielding.

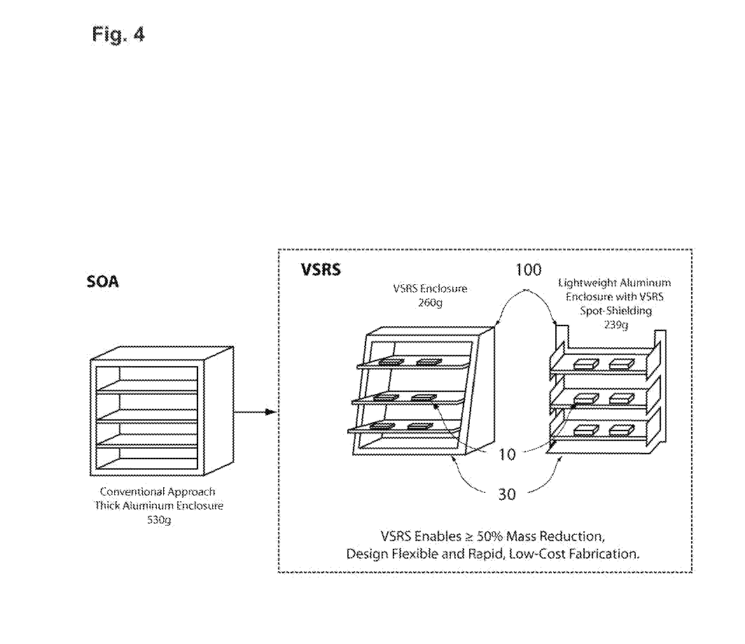

FIG. 4 shows Versatile Structural Radiation Shielding made by additive manufacturing in accordance with an embodiment. It comprises a high-Z layer 30 positioned between low-Z layers 10 and can be produced by 3D printing and reduces mass required to shield sensitive components.

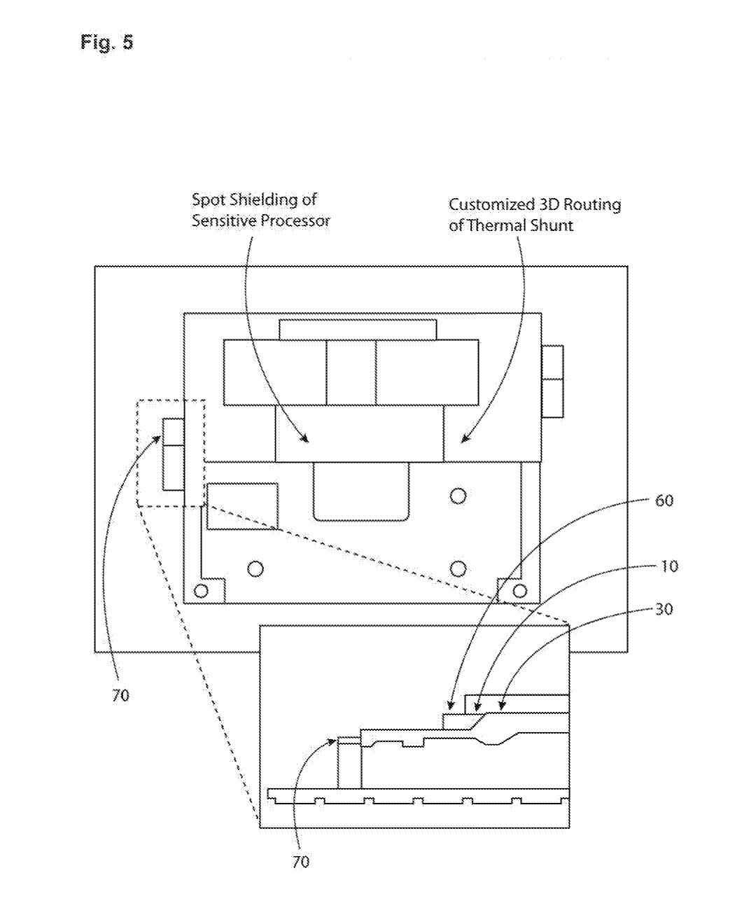

FIG. 5 shows Versatile Structural Radiation Shielding incorporating EMI shielding, radiation shielding, and a thermal shunt made by additive manufacturing in accordance with an embodiment.

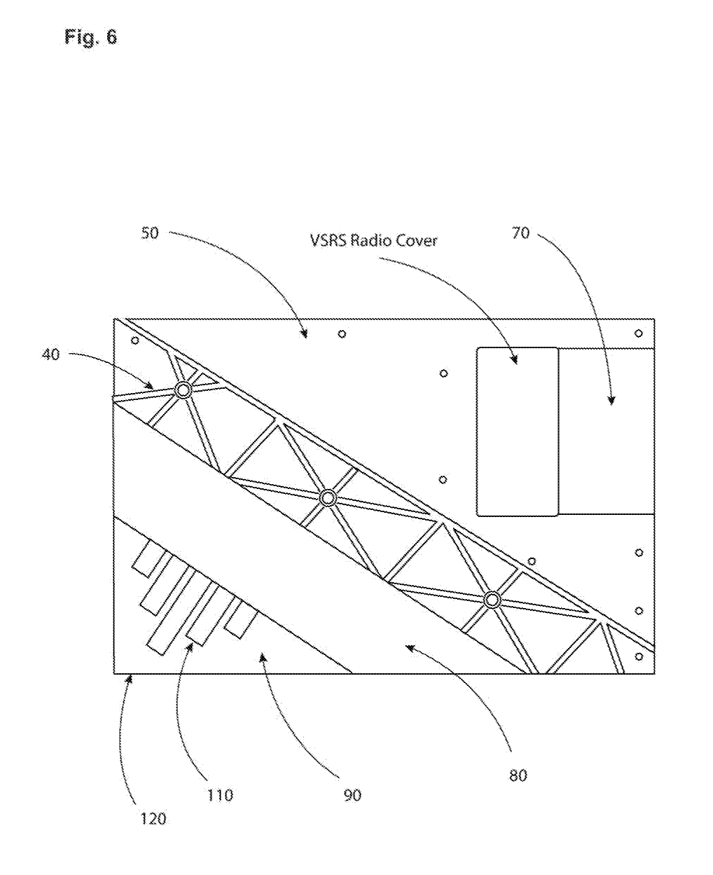

FIG. 6 shows Versatile Structural Radiation Shielding multifunctional isogrid paneling in accordance with an embodiment. It comprises a high-Z layer 30 and a low-Z layer 10, as well as a conductive EMI shielding layer 60 and a thermal shunt 70.

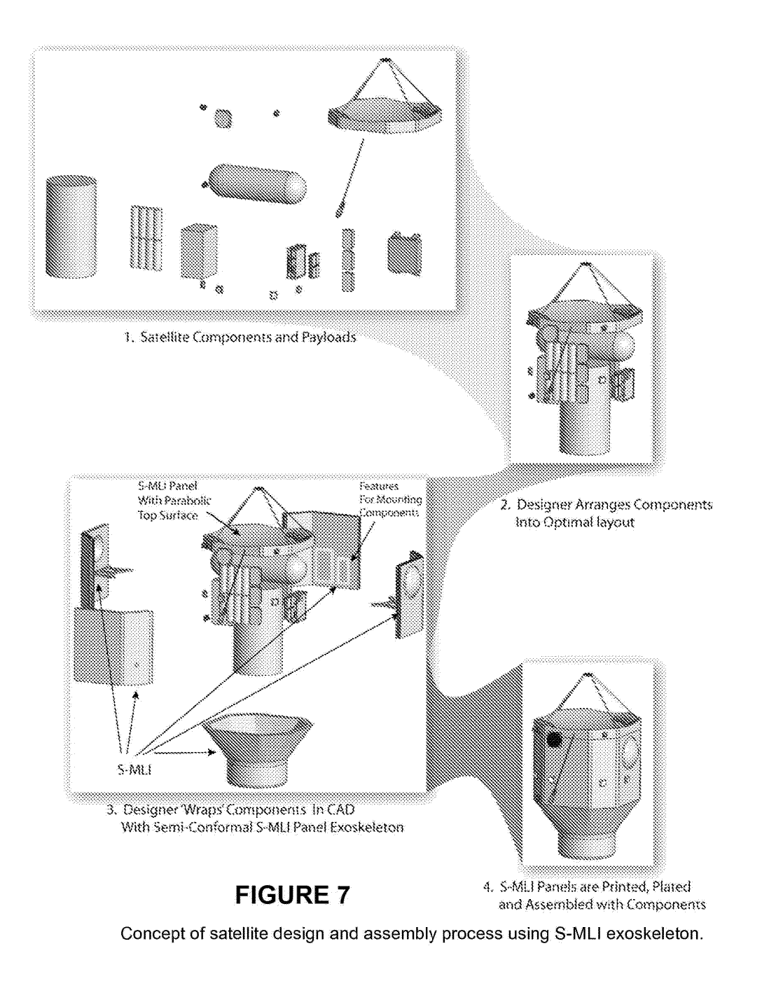

FIG. 7 shows a satellite design and assembly process using S-MLI exoskeleton in accordance with an embodiment. Step 1 comprises determination of satellite components and payloads. Step 2 comprises arranging satellite components and payloads into an optimum configuration. Step 3 comprises using a CAD program to “wrap” the optimally configured components and payloads in conformal Structural MLI. Step 4 comprises printing, plating, and assembling Structural MLI with the satellite's components and payload.

Structural Multi-Layer Insulation 100 plate thickness can be as thin as 0.045 in. (1.14 mm), and reduced the spacing to 0.090 in (2.28 mm). The addition of an additional layer to improve thermal performance, results in an overall panel thickness of 0.855 in (2.17 mm).

An example embodiment can comprise Structural Multi-Layer Insulation 100 having RTEN/HTEN layers. Electroless Nickel plating is able to plate interior surfaces of the structure without requiring the use of customized electrodes inserted into the structure, so it is well suited to achieve complete plating coverage of complex Structural Multi-Layer Insulation 100 geometries. An example embodiment can further comprise an Aeroglaze surface coating applied to the outer surface of the RTEN/HTEN to provide a top-layer emissivity comparable to beta cloth or other outer coatings typically used on MLI. The glaze has a solar absorptivity of ˜0.23, and an IR emissivity of ˜0.9.

An example embodiment comprises an RTEN/Cu/HTEN plated Structural Multi-Layer Insulation 100.

An example embodiment comprises a 3D representation of Structural Multi-Layer Insulation's shape stored on a computer readable medium, wherein said Structural Multi-Layer Insulation's shape comprises parallel sheets and spacers that connect adjacent parallel sheets. A computer connected to additive manufacturing hardware and running additive manufacturing software can use the 3D representation of Structural Multi-Layer Insulation's shape to instruct the additive manufacturing hardware to produce Structural Multi-Layer Insulation. An example of a 3D representation of Structural Multi-Layer Insulation's shape stored on a computer readable medium could comprise a CAD file.

The areal density of the S-MLI components is strongly dependent upon the thickness of the sheets or ‘leaves’ in the structure, as well as the thickness of the metallic plating applied. An approximately 45 mil thickness is at the lower end of manufacturer recommended minimum thicknesses; however, SLS and other 3D printing technologies can achieve significantly thinner feature sizes, so example embodiments can achieve further reductions in the leaf thickness so as to reduce the areal density of S-MLI structures. Since the stiffness of an example Structural Multi Layer Insulation 100 material will depend strongly upon the thickness of both the base material and the metallic plating, the flexibility of the 3D printing techniques affords the possibility of varying surface thicknesses throughout an S-MLI structure so as to minimize the structural mass by optimizing the mass distribution according to the stress distributions predicted by analysis.

A purely electroless Nickle plating process in accordance with an embodiment can be successful in terms of plating coverage and produces plated Structural Multi-Layer Insulation 100 that is relatively rigid, though not as stiff as the Ni/Cu/Ni parts. An example method comprising using an entirely electroless RTEN/HTEN process to produce curved Structural Multi-Layer Insulation 100 that can still be coated evenly on all surfaces.

A Ni/Cu/Ni plating process in accordance with an embodiment is not as well suited to complex geometries due to the restrictions on depth of the electrolytic copper plating step and warping that occurs with the electrolytic process would result in panels that may not fit properly together at the seams, potentially leaving gaps that would reduce the thermal performance of the structure.

Outgassing is typically an important issue in space applications. For thermal insulation in particular, outgassing condensates can dramatically alter the performance of thermal control surfaces, as well as foul optics and other sensors. Properly plated S-MLI components will have outgassing characteristics sufficiently low to be used on most or all satellites.

An electroless aluminum plating process makes S-MLI capable of stiffness performance comparable to conventional aluminum honeycomb.

S-MLI according to an embodiment can replace a conventional honeycomb-panel-plus-MLI combination to enable sensors to be mounted on the exterior of a spacecraft while maintaining good thermal control of the interior of the spacecraft.

Structural-MLI according to an embodiment can be designed and accurately modeled within a CAD package, and then fabricated rapidly using 3D printing. These features may enable the manner in which satellites are designed, fabricated, and integrated to be changed dramatically. In turn, these changes may enable significant reductions in cost and time from program start to launch.

S-MLI can be created using 3D printing methods in accordance with an embodiment, and these manufacturing processes allow three dimensional shapes to be built into the S-MLI. Such built in features can simplify the integration of satellite components and speed assembly of a spacecraft. Some of these potential features comprise:
mounting brackets or threaded bolt-holes for attaching sensors, antennas, payloads, and other components to both the exterior and interior of Structural-MLI;
“snap-lock” elements, hinges (such as butt, barrel, and mortise hinges), and threaded bolt joints to enable adjoining sections of S-MLI to be fitted together rapidly and securely;
multifunctional structural elements, such as parabolic concavities in the surface of SMLI to serve as an antenna reflector;
band-clamp structures or other such features to serve as the satellite side of a launch vehicle mounting/separation system;
channels built onto the interior surface of the S-MLI to facilitate rapid integration of cabling assemblies; and
heat pipe tubes integrated into the inner or outer surface of S-MLI.

An embodiment comprises a cubic satellite structure made of S-MLI. S-MLI structure comprises a layered box ‘wrapper’ with several external and internal mounting holes, as well as angled cable pass-throughs, and two layered lids. Lid and box edges comprise finger joints to minimize heat leakage through seams. Lids also possess locking tabs that keep them aligned with the box and facilitate rapid and secure assembly of the structure. This concept design illustrates a few of the more complex capabilities of the manufacturing process, particularly the ability to produce conformal panels for a variety of spacecraft structures and shapes.

In addition to enabling various features to be incorporated into S-MLI, the flexibility of 3D printing processes makes it possible to design satellites in a more rapid and mass-effective manner. Currently, when laying out the components of a spacecraft and designing the structures to hold them, satellite engineers are typically constrained to use structures that can be readily and cost-effectively created by machining flat plates of metal, small blocks of metal, flat honeycomb panels. More flexibility in shape is afforded by the use of composite structures, but fabricating these structures involves significant time and expense. Thus the arrangement of the satellite components is dictated in part by the practicality of fitting components to a structure that can be built easily. This conventional approach works, but significant improvements in system mass, cost, and assembly time may be achievable if the structures could be designed in a more organic manner and fabricated using a 3D printing process in accordance with an embodiment. For example, rather than first choosing a simple rectangular box structure large enough to hold all the components of a satellite, arranging the components to attach to the inner surface the box, running cabling as necessary, and then ballasting that box to achieve the necessary center of mass location, a satellite designer might first arrange all the components of a spacecraft in a CAD model in a manner to optimize cable lengths, center of mass, thermal distributions, and other such criteria. The designer could then use an automated CAD process to grow a 3D ‘skeleton’ structure to support these components in their optimal locations, and then ‘wrap’ the skeleton and components with a conformal S-MLI ‘exoskeleton’ using a second automated design process in accordance with an embodiment. After choosing optimal segmentation of skin panels and adding features such as cable pass-throughs and exterior sensor mounting brackets, the designer could accurately analyze thermal and structural performance of the satellite within the design toolset. The S-MLI panels and skeleton could then be printed and plated within a few hours, integrated with the satellite's payloads and components, tested, and launched. FIG. 7 illustrates this process. While such a process for design and construction is certainly a radical departure from conventional processes, and would require significant development and testing to gain acceptance within the industry, this “Printable Satellite” technology could enable satellites optimized for each emerging mission to be designed, fabricated, and integrated more rapidly and cost-effectively than using current techniques.

An embodiment can comprise developing a design for a flat-panel structural element incorporating an integrated multi-layer thermal barrier and using 3D printing and electroless plating techniques to fabricate this structure and coat it with metallic surfaces intended to both improve its radiative characteristics and significantly enhance its strength. This type of “Structural-MLI” can achieve an effective emissivity of 0.06±0.01, a value that is comparable to the effective emissivity of conventional MLI when it is installed on a spacecraft. Structural-MLI has strength comparable to typical aluminum honeycomb materials. In bending stiffness tests, Structural-MLI has a higher modulus of elasticity than a comparable aluminum honeycomb. Some embodiments of S-MLI have an areal density two to three times that of aluminum honeycomb, but other embodiments can improve strength-per-weight to make it fully competitive with aluminum honeycomb. Electroless aluminum plating techniques may enable the desired improvements. S-MLI embodiments have strong potential for creating spacecraft structures that provide thermal and strength performance comparable to the conventional approach of aluminum structure covered with an MLI blanket. Because S-MLI components can be manufactured using rapid prototyping techniques such as 3D printing, however, S-MLI can enable spacecraft structures with thermal insulation to be designed, analyzed, fabricated, and integrated in a dramatically more rapid and responsive manner.

There are a number of different rapid prototyping processes that could be used to fabricate Structural-MLI panels, prior to initiating prototype fabrication and testing. Most rapid prototyping processes use an additive process, meaning that the parts are built up layer by layer from some medium that is bound together in some way, either through the use of glues, or by melting the medium (sintering).

In choosing a process for the fabrication of S-MLI components, key factors are strength of the resultant product, off-gassing properties of the material used, ability to fabricate the desired structures, and cost.

Three Dimensional Printing (3DP)

A process patented by MIT, 3DP uses a powdered material medium that is laid down in layers by spreading a thin layer of the powder onto a work base atop a piston. A print head deposits a binder/resin to bond the powder together in the shape of the cross-section of the part at that layer, the piston is lowered and another layer of powdered material is rolled over the previous one. In some cases, these binders are temporary or fugitive glues, but in many cases, these materials remain in the final component. Examples of the latter include; ceramic particles in colloidal or slurry form, metallic particles in slurry form, dissolved salts which are reduced to metal in the powder bed, and polymers in colloidal or dissolved form. The un-bindered powder serves as support for the developing structure, and is removed later when the structure has hardened, as long as there are holes for the powder to exit. This process is fast and inexpensive, but the finished product may not be full density, and may need to be vacuum-impregnated with another material.

Typical resolution is on the order of 80-100 micron thick layers, and the particle sizes of the powder are typically 50-100 microns. Binder application resolution is about the same as an inkjet printer.

Any material that is available as a powder may be used in a 3DP process, even metals and ceramics. Ceramic molds for metal parts can be made after sintering and then fired to harden them. Such molds can then be used to cast metal parts.

Solid ceramic parts can be made directly, and can be retrieved from the printing process then isostatically pressed and fired, or sintered, to produce the final part. The standard 3DP process can be modified to directly produce parts with submicron powder. Known as Structural Ceramics, the newly developed slurry-based 3DP process enables layers as thin as 10 microns to be deposited. Solid metal parts can also be printed from a range of materials including steel, tungsten and tungsten carbide and then sintered, and may also be impregnated with lower melting temperature alloys to create full density parts.

A multiple nozzle printer allows for Local Composition Control (LCC). With LLC one can tailor the properties/material in any region of the part by utilizing different materials or binders in a plurality of print nozzles.

A fused deposition modeling process is similar to 3DP, but instead uses molten material that is ejected from the print nozzle to build up features. A “water-soluble” material can be used for making temporary supports while manufacturing is in progress, and can be quickly dissolved to leave the finished product.

Fused Deposition Modeling

Fused Deposition Modeling is most commonly used with ABS polymer materials. In addition, Fused Deposition Modeling technology can also be used with polycarbonates, polycaprolactone, polyphenylsulfones, waxes, and low melting point metals.

Selective Laser Sintering (SLS)

Selective Laser Sintering utilizes powdered materials just as 3DP does, but instead of injecting a binder, a high powered laser (usually CO2) is used to melt and fuse the medium. Materials used in this process include wide range of commercially available powder materials, including polymers (nylon, also glass-filled or with other fillers, and polystyrene), metals (steel, titanium, alloy mixtures, and composites) and green sand. Tolerances for SLS are comparable to the other additive processes described above (3DP, FUSED DEPOSITION MODELING), but the resulting parts are often fairly porous. Just as in 3DP, these can be infiltrated with another molten material to create denser parts.

Selective laser sintering can be performed with a wide range of materials. Unfortunately, most materials used by SLS vendors use proprietary formulations, so it is difficult to ascertain off-gassing properties without performing testing.

Stereo Lithography Apparatus (SLA)

Stereo Lithography Apparatus uses a UV curable resin that is cured using a focused UV laser. Resolutions are comparable to other processes described above. The resin material is quite expensive, and can cost anywhere from $300 to $800 per gallon.

Laminated Object Manufacturing (LOM)

In Laminated Object Manufacture, successive layers of laminate material (paper, plastic, metal) are laid down then features are cut using a knife or laser. Dimensional accuracy is slightly lower than the other additive processes. The process is inexpensive due to raw material availability, and can produce very large parts.

Electron Beam Melting (EBM)

Electron Beam Melting is essentially identical to the SLS process, except that an electron beam is used in place of the laser.

This process fully melts the material in a vacuum however, and produces fully dense parts, and so requires no post processing with infiltration.

Metallization Of Rapid Prototyped Parts

For spacecraft structure applications, both the material strength and off-gassing properties of many of the polymer-based materials used in the aforementioned rapid prototyping processes are of concern. In accordance with an embodiment, metallization of these materials after printing may provide a means for addressing both issues. Electro-less nickel and electroplated copper can be applied in thicknesses ranging from 0.025 mm to 0.12 mm with current processes, and this ‘exoskeleton’ 20 of metal around the polymer structure can provide 50-70% of the strength per weight of an equivalent aluminum structure. Metallization of the parts can also improve the emissivity/absorptivity characteristics of the layers of the S-MLI.

An embodiment can comprise using SLS to produce a structure and using a metal plating process developed specifically for polymer parts made by rapid prototyping processes.

An embodiment can comprise producing a structure made of glass-filled nylon, then plating the structure in a three step process to produce a thin yet strong metal skin composed of nickel and copper. The skin provides up to four times the natural strength of the nylon by itself, and seal the plastic against outgassing. The nickel outer coating can provide layer surface emissivity of as low as 0.4, and possibly lower

An embodiment can comprise using a higher temperature version of the SLS process that can produce parts made from PEEK (Polyaryl Ether Ether Ketone), a low outgassing polymer qualified for use in ultra-high vacuum applications.

An example method comprises using additive manufacturing processes such as 3D printing, Fused Filament Fabrication (FFF), and Selective Laser Sintering (SLS) to fabricate structural components that have internal microstructure and/or controlled internal variation of material composition in order to provide multi-functional capabilities such as radiation shielding, thermal isolation, Electromagnetic Interference (EMI) shielding, tailored thermal conductance paths, and tailored electrical conductance paths.

An example method uses 3D printing techniques to fabricate 3-dimensional structural components for spacecraft, aircraft, and other systems in such a way that the components have internal structures such as voids as well as controllably varied material composition with combinations of polymers, conductors, high strength fibers, and high atomic weight metals.

An example “Structural Multi-Layer Insulation” (S-MLI), comprises a structural ‘exoskeleton’ for spacecraft that has a durable outer surface and a strong inner layer suitable for mounting avionics and other equipment, with the inner and outer surfaces separated by multiple conformal thin shells separated by voids in order to minimize thermal conductance and radiative transfer between the inner and outer surfaces.

An example method comprises a process to fabricate Versatile Structural Radiation Shielding components such as avionics enclosures or conformal covers for electronics boards using combinations of low atomic weight (low-Z) polymers and high atomic weight (high-Z) metals, varying the composition to create a layered graded-Z internal structure that attenuates space radiation more effectively than an equal mass of aluminum or tantalum shielding.

An embodiment can comprise structural components having conductive paths for connecting sensors, antennas, and other electronic components. An embodiment can incorporate thermally conductive paths into a structure to transfer heat generated by a component mounted on the structure to another location on the structure. Layers of conductor can be incorporated to provide EMI shielding.

An example method can comprise a step wherein a structural component is designed in CAD. A further step can comprise software macros or manual design being used to integrate sub-structures with varied density and material composition into the design. A further step comprises the part being fabricated by a 3D printing process, building the part up in a sequence of layers, wherein multiple material feed stocks can be used to controllably vary the material composition and density. These material feed stocks can comprise low-atomic weight polymers, high-atomic weight metals, conductive metals, and fibers. After printing, a step can comprise the part being coated with metals or other materials to achieve a desired thermal emissivity, conductivity, encapsulation, or strength enhancement.

An example method can comprise the use of 3D printing to create components with complex internal structures and varied material compositions to provide tailored multifunctional capabilities. The 3D printing process enables the component to be built up in a layered fashion, enabling density and materials to be varied throughout the component.

An example process comprises the use of 3D printing techniques to fabricate structural components with complex internal structure.

Structural MLI in accordance with an embodiment can have a durable outer surface, can be fabricated rapidly and at affordable cost, and its performance can be predicted accurately by software analysis tools. Versatile Structural Radiation Shielding in accordance with an embodiment can reduce the mass required for a given radiation attenuation level by a factor of 3. Versatile Structural Radiation Shielding parts can be fabricated rapidly, repeatedly, in an automated manner, and at affordable cost. Additionally, shielding performance can be predicted accurately by modeling tools.

Versatile Structural Radiation Shielding in accordance with an embodiment can be used for medical equipment parts with shielding for x-rays or other radiation sources.

A Versatile Structural Radiation Shielding (VSRS) production method in accordance with an embodiment allows radiation shielding to be rapidly manufactured through additive manufacturing, enabling easy implementation of graded-Z shielding in arbitrarily complex geometries. Furthermore, the resulting radiation shielding can be made to serve many purposes, including: spacecraft structure, electro-magnetic interference (EMI) shielding, multilayer micrometeoroid protection, multi-layer thermal insulation, tailored thermal conductance paths, as well as providing protection for satellite outer surfaces.

Graded-Z shielding uses layers of materials selected to optimize the absorption and scattering of incident radiation as the radiation propagates through the material. The best mass-efficiency for stopping proton and electron radiation is provided by low atomic number (low-Z) elements such as hydrogen. High-performance polymers such as PEEK are composed predominantly of hydrogen and other low-Z elements and are thus the lowest effective-Z that is feasible for use as structural radiation shielding. As charged particles are decelerated and scattered by the low-Z material, however, they produce bremsstrahlung radiation, primarily in the form of X-rays. High-Z metals such as tungsten or tantalum are the most efficient at shielding against bremsstrahlung and x-ray (gamma) radiation. As bremsstrahlung radiation is absorbed by the high-Z material, it can produce secondary charged particles. An additional inner layer of low-Z material can serve to efficiently attenuate these secondary charged particles.

An example method for fabrication of Versatile Structural Radiation Shielding comprises using Fused Deposition Modeling (FDM) to additively manufacture with combinations of space-grade high-performance polymers and polymer-entrained high-Z metals. Implementing this capability required developing new techniques to enable Fused Deposition Modeling of polymers with much higher melting temperatures than common FDM materials (eg. 350° C. for PEEK, vs. 220° C. for PEI, also known as Polyetherimide). An example method can comprise techniques for controllably varying the composition of the material throughout the build process, to quickly and affordably make layered (low-high-low-Z) shielding integral to the part. Controllability and variability is helpful to enable mitigation of thermal expansion induced stresses in the structure, which could otherwise cause warping or other distortions.

3D printing techniques allow creation of complex geometries to fit into tight spaces and tailor the thickness and composition of the shielding to minimize material for a given service environment.

A Versatile Structural Radiation Shielding (VSRS) production method in accordance with an embodiment allows creation of a wide array of new multifunctional spacecraft components for a range of application areas. Versatile Structural Radiation Shielding components can be printed affordably and quickly at flight-ready quality, and in geometries that serve multiple purposes. A Versatile Structural Radiation Shielding (VSRS) production method in accordance with an embodiment allows production of covers and enclosures for space avionics that have integral graded-Z shielding, reducing by a factor of more than 2 the mass required to house and shield avionics using conventional aluminum enclosures.

Embodiments can integrate additional materials into a fabrication process to create components that can provide additional capabilities, such as avionics shields with integrated thermal dissipation shunts, satellite exoskeletons with radiation shielding and multi-layer thermal insulation, and conductive elements such as embedded antennas and electrical feeds.

Within the current funding environment, there are strong pressures towards shorter mission development times on tighter budgets, and there is a strong desire to achieve higher performance at a lower cost. Consequently, there is increased interest in use of COTS and non-rad-hard components to achieve better performance-per-cost. Radiation shielding can mitigate the risks associated with using these lower-cost, higher-performance components in a radiation environment. However, traditional shielding techniques, such as using thicker aluminum structures and spot shielding with tantalum sheets, are costly both in terms of mass and labor hours. The rapid evolution of additive manufacturing and materials science provides us an opportunity to take a different approach to shielding spacecraft components that can enable significant improvements in mass, cost, and schedule. High-performance polymers, such as PEEK, have shown a good flight history and have impressive mechanical properties, negligible outgassing, and wide operating-temperature ranges. Computer modeling and computation power have enabled rapid calculation and optimization of radiation shielding using these materials. While the optimized designs may be difficult to fabricate using traditional subtractive-manufacturing methods, they are straightforward to create using additive manufacturing. The use of additive manufacturing also allows the radiation shielding component to serve additional functions, from structure to multi-layer insulation, allowing for reduced-mass and more compact implementation of satellite capabilities.

Radiation shielding allows the radiation environment surrounding the satellite to be attenuated to levels suitable for the electronics inside the satellite to operate over the lifetime of the mission and at the desired reliability required by the mission. Typically, it is only feasible to shield against the proton and electron components of the radiation environment, as the necessary shielding thicknesses, and thus masses, are manageable. Deflection or absorption of high-energy neutron and gamma radiation requires significantly more material mass than is typically cost effective to incorporate into a satellite, but can be achieved using the Versatile Structural Radiation Shielding technology if the mass-budget of the mission allows.

When considering a shielding method for spacecraft in GEO, the design must slow both the electron and proton radiation components. A low/high/low-Z layering, as shown in FIG. 1, provides a 60% mass savings to achieve the same shielding as a single layer of aluminum. While the optimal shield for protons would consist of one low-Z material layer, the multi-layer shield for electrons typically incurs no performance penalty with the protons. The high-Z layer 30 that is part of the electron shielding scheme does not increase the dose through secondary particles as long as a low-Z layer 10, 50 is situated adjacent to the electronics. This graded-Z approach introduces the best material 10 to the incident radiation first, and then the best material for the generated secondary particles 30 is introduced second. Thus, the optimal electron shield will be very effective for shielding protons as long as the last low-Z layer 50 has sufficient thickness.

Suitable FDM-compatible materials comprise PEEK and tungsten. Novel material feed stocks and FDM techniques enable 3D printing with combinations of high performance PEEK polymer and metal-entrained polymers.

An embodiment can comprise using an FDM process to fabricate S-MLI. An alternate embodiment can comprise using an SLA process to fabricate S-MLI. Using an FDM process allows using higher-performance space-rated polymers such as PEEK, and allows greater control over the mixing and ratio of the low-Z (PEEK) to high-Z (PEEK entrained tungsten) in the Versatile Structural Radiation Shielding materials.

A method according to an embodiment can comprise one or more Additive Manufacturing options comprising: Fusion Deposition Modeling (FDM); Stereo Lithography (SLA); Solid Free Form (SFF); Selective Laser Sintering (SLS); Digital Printing or 3DP; Objet's PolyJet systems; Laminated Object Manufacturing (LOM); and Ultrasonic Additive Manufacturing (UAM).

Fusion Deposition Modeling (FDM) systems can print with multiple materials. Each material is supplied as a source of round filament that is melted and deposited in sequential layers. Equipment costs are low, and the design is easily adapted to different print configurations and materials. This approach is compatible with high-performance space-qualified polymers.

Stereo Lithography (SLA) systems have the ability to render high-fidelity parts, but are limited to a single material for each print and require photo curing resins that limit the available materials for use with this approach and that are expensive to develop or modify.

Solid Free Form (SFF) systems are capable of printing multiple materials and are able to print with any viscous material that can be squirted through a nozzle. However, this technology has poor resolution as well as slow material hardening times that make it impractical for printing large, high-fidelity parts.

Selective Laser Sintering (SLS) systems are capable of using a large variety of thermoplastic materials. SLS systems build up a structure by sequentially spreading layers of powdered material and then selectively laser sintering the powder to form a solid structure. SLS is not yet well suited for integrating multiple materials in a single build and the cost of the equipment would increase development costs of the Versatile Structural Radiation Shielding technology.

Digital Printing (3DP) uses inkjet technologies to deposit binder into powder-based composites layers. This method enables multi-color parts, though the parts have very low resolution and are brittle. Currently, multi-material parts cannot be made with this process. However, direct printing of conductive inks onto Solid Freeform Fabrications (SFF) parts can be done.

Objet's PolyJet systems are capable of printing 5 or more substrates simultaneously. This printer uses a jetted photo-curing resin to build an object.

Laminated Object Manufacturing (LaM) comprises a step where profiles of object cross sections are cut from a spool of paper using a CO2 laser. The paper is unwound from a feed roller and then bonding material is added between the profile layers as they are stacked upon one another to build objects. The process is not clean and generates significant quantities of smoke, requiring a closed chamber or filtration system. This approach has a poor outlook on adapting the design to use high-performance polymers in a manner that would not outgas.

Ultrasonic Additive Manufacturing (UAM) allows material layups to be tailored to fabricate objects capable of meeting a large range of structural, thermal, and physical demands (i.e. embedded fibers, smart materials, cladding). Embedded channels for thermal management can be formed from wires, tapes or meshes, all within a metal matrix.

The following factors are considerations for additive manufacturing process selection:
cost of feedstock materials and reliance upon vendors and timelines
lead time of delivery of VSRS hardware to customers
ability to control the high-Z material concentration
amount of touch labor required
consistency of fabrication process
necessity to retain expertise between projects (personnel)

Embodiments can comprise using combinations of additive manufacturing and conventional manufacturing processes. An example process can comprise using FDM process to fabricate Versatile Structural Radiation Shielding comprising polymer entrained tungsten.

The FDM process is well suited to produce versatile structural radiation shielding for the following reasons:
high-Z thermoplastic compounds such as PEEK/W can be directly formed into complex 3D radiation shields by this single process.
FDM, like SLS, is capable of printing with high performance thermoplastics such as PEEK.
FDM allows multiple materials to be fed simultaneously at specified amounts throughout the entire build process of an object. The SLS process, the nearest competitor to FDM, is currently only capable of printing with a single material.
Dual feed FDM allows for highly customizable 3D concentrations of Low-Z and High-Z materials throughout an entire object and is suited for producing contoured shielding. SLS and subsequent coating methods limits layered shielding materials to a single planar orientation and a uniform thickness across each layer.

Versatile Structural Radiation Shielding according to an embodiment could comprise high-performance polymers such as PEEK (Poly Ether Ether Keytone), and PEI (Polyetherimide, also known as Ultem®) whose physical properties include high temperature and low outgassing characteristics, as well as less expensive materials such as ABS (Acrylonitrile butadiene styrene), and PLA (Polylactic acid), HDPE (High density polyethylene) that, after being plated, may have suitable outgassing levels. The relevant material characteristics include service and glass transition temperatures, coefficient of thermal expansion (CTE), tensile strength and modulus, outgassing Total Mass Loss (TML) and Collected Volatile Condensable Materials CVCM, as well as cost.

A method of producing Versatile Structural Radiation Shielding in accordance with an embodiment could comprise using various feed mechanisms, heated die configurations, heated beds and substrate materials and thermal control systems.

Versatile Structural Radiation Shielding constructed with PEEK in accordance with an embodiment can provide a desired radiation attenuation level with less than half the mass required for aluminum, and less than a third of tungsten. However, it should be noted that because PEEK has a lower density than these metals, it will require a larger volume than aluminum or tungsten for a given attenuation. Nonetheless, because Versatile Structural Radiation Shielding integrates graded-Z shielding into a structural component, and because the use of 3D printing enables fabrication of very complex 3D structures that can fit in between other components, this significantly mitigates volume impacts. For example, in an avionics stack, a Versatile Structural Radiation Shielding element can be designed and fabricated to fit conformally in between two electronics boards, providing both shielding and structural support.

A Versatile Structural Radiation Shielding embodiment comprises high-Z metals for their radiation shielding properties. Methods of producing Versatile Structural Radiation Shielding comprising high-Z materials in accordance with an embodiment include electro/electroless-plating, vapor deposition, and entraining a high-Z material in a feedstock polymer. A high-Z material in accordance with an embodiment could comprise tungsten which has high performance in radiation shielding, good availability, and lower cost than tantalum or gold, and its inert character and suitability for polymer entrainment. Polymer entrainment offers the low risk process, process that adds no extra steps to a fabrication process, reduces touch labor, and provides control over deposition in the part.

Tungsten provides a Z2/A ratio very near to that of gold or tantalum, making it effective at slowing electrons through the creation of bremsstrahlung and at absorbing bremsstrahlung produced in earlier shielding layers. The cost of tungsten is significantly lower than the cost of gold or tantalum, and is readily available in powdered form at the granule sizes of interest for compounding Versatile Structural Radiation Shielding feedstock material. These properties make tungsten an appropriate high-Z material for Versatile Structural Radiation Shielding in accordance with an embodiment.

A method of producing Versatile Structural Radiation Shielding in accordance with an embodiment comprises mixing tungsten into polymer, a process called compounding, that results in homogenized PEEK/W pellets. This step can be done in tandem with extrusion, the process by which filaments of polymer are produced. The filaments by these steps comprise the feedstock for an FDM process. Alternatively, compounding for polymer-entrained tungsten can be done separately.

An alternate embodiment of Versatile Structural Radiation Shielding could comprise HDPE/W that was compounded and extruded at the same time.

A method of producing Versatile Structural Radiation Shielding in accordance with an embodiment comprises compounding PEEK with a high-Z material such as tungsten, then extruding tungsten entrained PEEK in a separate step.

An example method comprises compounding HDPE with tungsten (forming HDPE/W), and extruding HDPE/W into filament, then using an FDM machine to print Versatile Structural Radiation Shielding in accordance with an embodiment.

An example method comprises compounding PEEK with tungsten (forming PEEK/W), and extruding PEEK/W into filament, then using an FDM machine to print Versatile Structural Radiation Shielding in accordance with an embodiment.

An example method comprises using a dual-feed head FDM machine to rapidly print radiation shielding components with graded-Z shielding optimized for a given radiation environment, wherein one feed head prints high-Z material and another feed head prints low-Z material, wherein flow rates through each feed head are variable, and wherein the thickness of the high-Z and low-Z layers are tailored throughout the Versatile Structural Radiation Shielding, such that more shielding is allocated to the most sensitive components and mass is saved by using thinner shielding on less sensitive parts.

A method of manufacture according to an embodiment can comprise using 3D printing to fabricate structures with integral graded-Z radiation shielding. Such a method could further comprise refining and then qualifying Versatile Structural Radiation Shielding graded-Z shielding, and developing and integrating additional materials into the process to enable Versatile Structural Radiation Shielding to provide additional functionalities.

A method of manufacture according to an embodiment can comprise integrating high-performance polymers such as PEEK, that are suited to space applications by having little to no outgassing, high strength, and a large operating temperature range, with a high-Z additive such as tungsten (W) to provide high attenuation of bremsstrahlung radiation. Further embodiments can comprise methods for integrating other additives to provide capabilities for EMI shielding, thermal and electrical conductivity, increased stiffness, and protection from AO and UV. Versatile Structural Radiation Shielding with additional materials within a polymer matrix according to an embodiment can comprise:
spot covers & conformal radiation shields;
structural minimum-mass radiation-shielding enclosures;
EMI shielding and integral wiring or antennas using conductive additives;
thermally-conducting shielding having polymer additives (such as carbon fiber);
thermally-insulating radiation shielding comprising MLI structures;
thermally conductive shielding having an imbedded micro-channel heat pipe;
satellite external structure that protects against atomic oxygen;
satellite exterior protection that protects against vacuum ultraviolet radiation and UV; or
satellite exterior thermal control coatings.

This sequence of applications represents a natural evolution of the capability of the technology, allowing the radiation shielding to be augmented with variable thermal and EM properties to tailor the environment around the protected electronics.

An additive manufacturing process used to create Versatile Radiation Shielding in accordance with an embodiment allows various additives to be strategically placed throughout an object during the build process. A Versatile Structural Radiation Shielding rapid fabrication process in accordance with an embodiment allows for mass and material savings as structures can be completely optimized to balance mechanical, electrical, thermal, and environmental durability characteristics. Versatile Structural Radiation Shielding (Versatile Structural Radiation Shielding) in accordance with an embodiment comprises adaptation of additive manufacturing technology to produce structures having integral graded-Z radiation shielding. An embodiment can integrate additional materials to enable these components to also provide EMI shielding, thermal insulation and/or transfer, and MM/OD shielding. The use of 3D printing enables these components to be designed, analyzed, and fabricated in an affordable and responsive manner. An embodiment allows the cost of shielding satellites from radiation to be greatly reduced, while performance is increased. Radiation shielding permits enhanced mission lifetimes of COTS electronics and allows operation in orbital environments that were previously excluded.

Development of Versatile Structural Radiation Shielding technology in accordance with an embodiment will enable spacecraft with energetic particle and thermal shielding to be designed, built, and integrated more responsively than with conventional structure plus shielding methods. The rapid fabrication times afforded by additive manufacturing as well as good agreement between predictions and measurements of performance will enable spacecraft with even relatively complex structural and shielding geometries to be designed, verified in software, fabricated, and integrated within very rapid timelines. A development cycle in accordance with an embodiment enables rapid- within seven days- design, analysis, fabrication, and integration of a small satellite.

An embodiment can integrate high-Z materials with additional high-strength and conductive materials. In accordance with an embodiment, it is possible to develop a full end-to-end process for rapidly and affordably designing, analyzing, and fabricating multifunctional spacecraft components that can combine minimum-mass radiation shielding customized for the operational environment along with structural strength, EMI shielding, heat dissipation, electrical conduction, thermal insulation, and MMOD protection.

The above description is illustrative and is not limiting. The present invention is defined only by the following claims and their equivalents.

1. A structural spacecraft component comprising internal microstructure;
wherein said microstructure comprises a plurality of parallel sheets and a plurality of spacers that connect adjacent parallel sheets; and
wherein said structural spacecraft component is a product of an additive manufacturing process.

2. A structural spacecraft component as in claim 1, wherein said additive manufacturing process comprises 3D printing.

3. A structural spacecraft component as in claim 1, wherein said additive manufacturing process comprises fused filament fabrication.

4. A structural spacecraft component as in claim 1, wherein said additive manufacturing process comprises selective laser sintering.

5. A structural spacecraft component as in claim 1, wherein said spacecraft component comprises a plurality of materials such that material properties vary within said spacecraft component's structure.

6. A structural spacecraft component as in claim 5, wherein said plurality of materials comprises one or more of polymers, high strength fibers, conductors, and high atomic weight metals.

7. A structural spacecraft component as in claim 1, wherein said spacecraft component comprises structural multilayer insulation.

8. A structural spacecraft component as in claim 7, wherein said parallel sheets comprise polymer;
and wherein said plurality of spacers comprise polymer.

9. A structural spacecraft component as in claim 7, further comprising an outer layer of metal plating applied to the surfaces of said polymer sheets and polymer spacers.

10. A structural spacecraft component as in claim 1, wherein said spacecraft comprises versatile structural radiation shielding.

11. A structural spacecraft component as in claim 10, wherein said versatile structural radiation shielding comprises at least one sheet of low atomic weight polymer and at least one sheet of a high atomic weight metal; and
wherein said sheet of low atomic weight polymer and said sheet of high atomic weight metal are parallel.

12. A structural spacecraft component as in claim 11, further comprising a plurality of additional parallel sheets having different Z values and spacers that connect adjacent parallel sheets;
wherein said sheets are arranged as graded Z shielding.

13. A structural spacecraft component as in claim 11, further comprising at least one EMI shielding sheet that is parallel to said sheets and wherein said EMI shielding sheet is connected to at least one parallel sheet by a plurality of spacers.

14. A structural spacecraft component as in claim 11, further comprising a thermal shunt.

15. A structural spacecraft component as in claim 1, wherein said spacers are arranged in a tread pattern.

16. A structural spacecraft component as in claim 1, wherein said spacers comprise at least one isogrid.
